(19) United States
(12) Patent Application Publication
(10) Pub. No.: US 2005/0162860 A1
(43) Pub. Date: Jul. 28, 2005

(54) Auxiliary spotlight diaphragm of an automobile light

(76) Inventor: Shiu-Chun Su, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/761,437

(22) Filed: Jan. 22, 2004

(51) Int. Cl. F21V 17/02

(52) U.S. Cl. 362/512

(57) ABSTRACT

An automobile light with an auxiliary spotlight diaphragm includes a light base, a spotlight diaphragm and a light cover. The light base is provided with a light source body therein, and the spotlight diaphragm is pivotally provided around the outer circumference of the light source body. The characteristic of the present invention lies in that the spotlight diaphragm is composed by a first light-reflection portion, a second light-reflection portion, a third light-reflection portion and a flickering diode. At least one hollow is provided in a predetermined position of the first light-reflection portion, so as for the flickering diode to be inserted through and inlaid in the second light-reflection portion.

### BACKGROUND OF THE INVENTION

1. Field of the Invention

The present invention relates to an auxiliary spotlight diaphragm, which is provided around an automobile light to let an automobile light provide best illumination. More particularly, the present invention is directed to an auxiliary spotlight diaphragm, which is provided with three light-reflection portions and a flickering diode and can promptly and effectively make an automobile light be more brilliant, so as to improve the function of warning.

2. Description of the Related Art

Referring to FIG. 1, an automobile light provided with a conventional auxiliary spotlight diaphragm includes a light base 1, a spotlight diaphragm 2 and lighting articles 3.

The light base 1 is provided with a light 11 and a light-reflection cover 12. The light 11 may be a brake light, a fog light or a headlight; and two fixing posts 13 are provided on the surface of the light-reflection cover 12 for receiveing fixing posts 21 of the spotlight diaphragm 2 and being screwed by screws 4.

The spotlight diaphragm 2 is a transparent ring, two fixing posts 21 are provided on the spotlight diaphragm 2 respectively according to the fixing posts 13 of the light base 1, fixing inlay hollows 22 are provided in the spotlight diaphragm 2 at a spaced distance, two opposite lighting articles 3 are inlaid in each fixing inlay hollow 22, the lighting articles 3 may be flickering diodes and must be driven to operate by driving electric circuit. One light-relection unit 23 is provided on one side surface of the spotlight diaphragm 2, the light-relection unit 23 is composed by several spaced crystals, and each crystal is provided with slant tangent planes, so as to have the function of enlarging and gathering light.

Referring to FIG. 2, when being lightened up, the light 11 can provide illumination by means of the projection of light-reflection cover 12, the lighting articles 3 in the fixing inlay hollows 22 will flicker one by one, and then the light-relection unit 23 of the spotlight diaphragm 2 will gather the brightness of the lighting articles 3 first. Alternatively, the lighting articles 3 in the fixing inlay hollows 22 can be lightened up all together at the same time, and then the light-relection unit 23 of the spotlight diaphragm 2 will gather the brightness of the lighting articles 3, so as for the circumference of the light 11 to form a brilliant ring and to have the effect of warning.

However, the above-mentioned conventional structure of an auxiliary spotlight diaphragm of an automobile light can not promptly enough gather the light to let an automobile light provide the quickest and brightest illumination for warning.

### SUMMARY OF THE INVENTION

Therefore, the present invention is designed to provide an auxiliary spotlight diaphragm of an automobile light that substantially obviates the drawbacks of the related conventional art.

An object of the present invention is to provide an auxiliary spotlight diaphragm, which is provided around an automobile light to let the automobile light provide the quickest and most brilliant illumination.

Another object of the present invention is to provide an auxiliary spotlight diaphragm, which is provided with three light-reflection portions and a flickering diode and can make the automobile light be more brilliant so as to improve the function of warning.

Accordingly, an automobile light with an auxiliary spotlight diaphragm in the present invention includes a light base, a spotlight diaphragm and a light cover. The light base is provided with a light source body therein, and the spotlight diaphragm is pivotally provided around the outer circumference of the light source body. The characteristic of the present invention lies in that the spotlight diaphragm is composed by a first light-reflection portion, a second light-reflection portion, a third light-reflection portion and a flickering diode. At least one hollow is provided in a predetermined position of the first light-reflection portion, so as for the flickering diode to be inserted through and inlaid in the second light-reflection portion. By means of the light source from the flickering diode lighting the first light-reflection portion, the second light-reflection portion and the third light-reflection portion, and because of the light-reflection function of the first light-reflection portion and the third light-reflection portion, the automobile light can quickly provide best illumination and be more brilliant to improve the function of warning.

### BRIEF DESCRIPTION OF THE DRAWINGS

Other features and advantages of the present invention will become apparent in the following detailed description of the preferred embodiments with reference to the accompanying drawings, in which:

FIG. 1 is a perspective exploded view of a conventional auxiliary spotlight diaphragm of an automobile light;

FIG. 2 is a front view of the conventional auxiliary spotlight diaphragm of an automobile in assembled configuration;

FIG. 3 is a perspective exploded view of an embodiment of the auxiliary spotlight diaphragm of an automobile light in accordance with the present invention;

FIG. 4 is a front view of an embodiment of the auxiliary spotlight diaphragm of an automobile light in assembled configuration in accordance with the present invention;

FIG. 5 is a perspective exploded view of another embodiment of the auxiliary spotlight diaphragm of an automobile light in accordance with the present invention; and,

FIG. 6 is a front view of another embodiment of the auxiliary spotlight diaphragm of an automobile light in assembled configuration in accordance with the present invention.

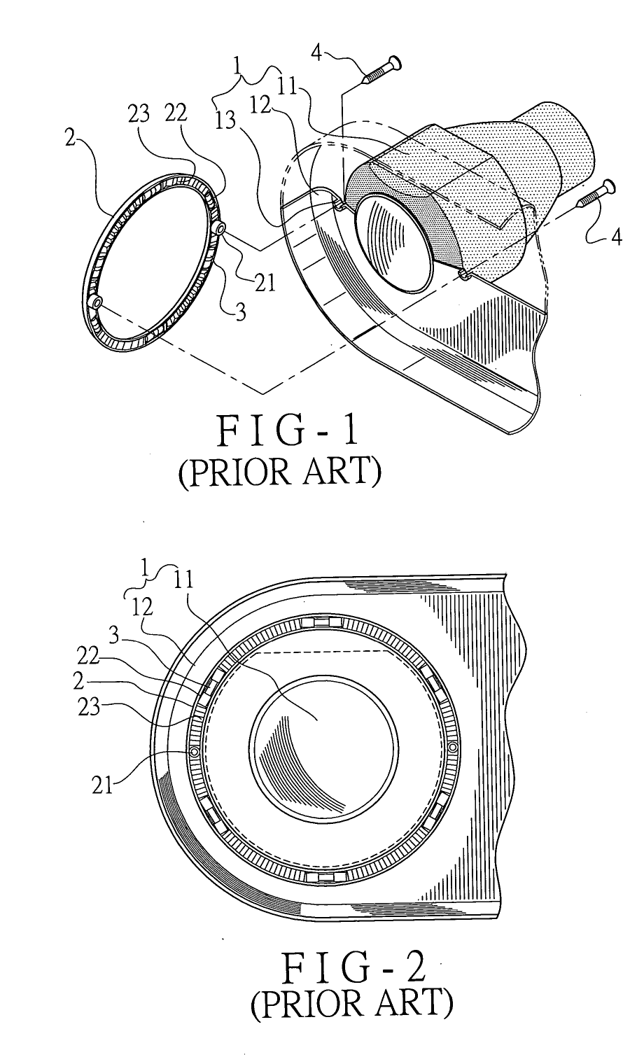

### DETAILED DESCRIPTION OF THE PREFERRED EMBODIMENTS

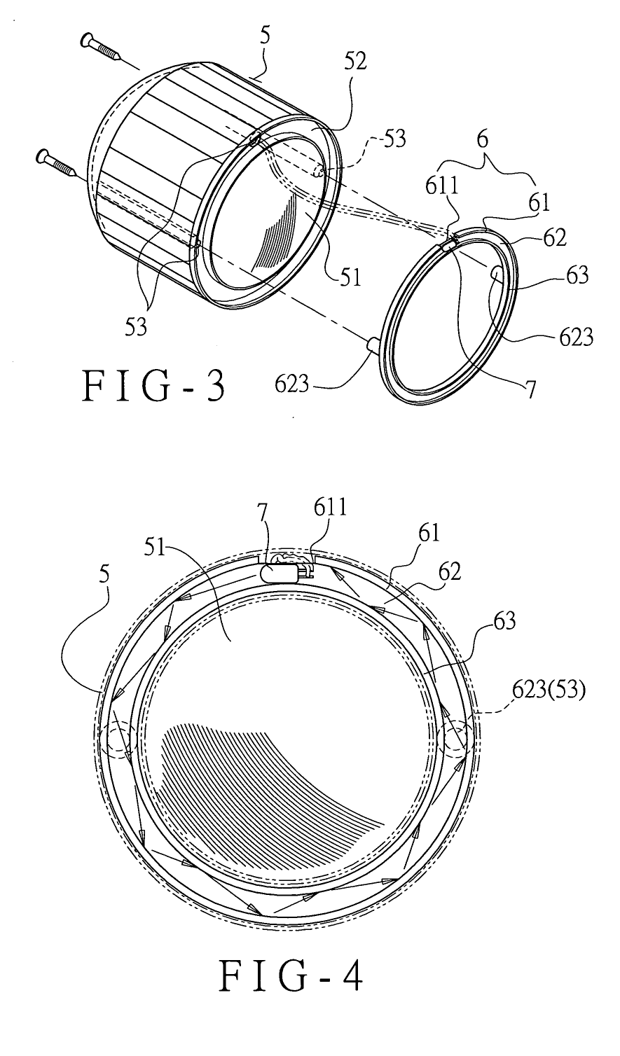

Referring to FIGS. 3 and 4, a preferred embodiment of an automobile light with an auxiliary spotlight diaphragm in the present invention includes a light base 5, a spotlight diaphragm 6 and a flickering diode 7.

The light base 5 is provided with a light source body 51 therein, the light source body 51 provides the main light source for illumination, an outer ring groove 52 is provided in the front end of the light source body 51 for receiving the spotlight diaphragm 6, and at least three holes 53 are provided in the predetermined positions of the outer ring groove 52.

The spotlight diaphragm 6 is designed to inlay in the outer ring groove 52 and pivotally provided around the outer circumference of the light source body 51. The spotlight diaphragm 6 is composed by a first light-reflection portion 61, a second light-reflection portion 62, and a third light-reflection portion 63. One hollow 611 is provided in a predetermined position of the first light-reflection-portion 61, so as for the flickering diode 7 to be inserted through and inlaid in the second light-reflection portion 62. A pair of opposite connecting rods 623 are provided on the bottom of the second light-reflection portion 62 so as to respectively insert in two oposite holes 53 in the outer ring groove 52 for assembly. The flickering diode 7 is provided to place in the hollow 611 and then inlaid in the second light-reflection portion 62.

When being driven, the light source from the flickering diode 7 projects on the first light-reflection portion 61, the second light-reflection portion 62 and the third light-reflection portion 63, and because of the light-reflection function of the first light-reflection portion 61, the second light-reflection portion 62 and the third light-reflection portion 63, the automobile light can quickly provide the best illumination and be brilliant for warning.

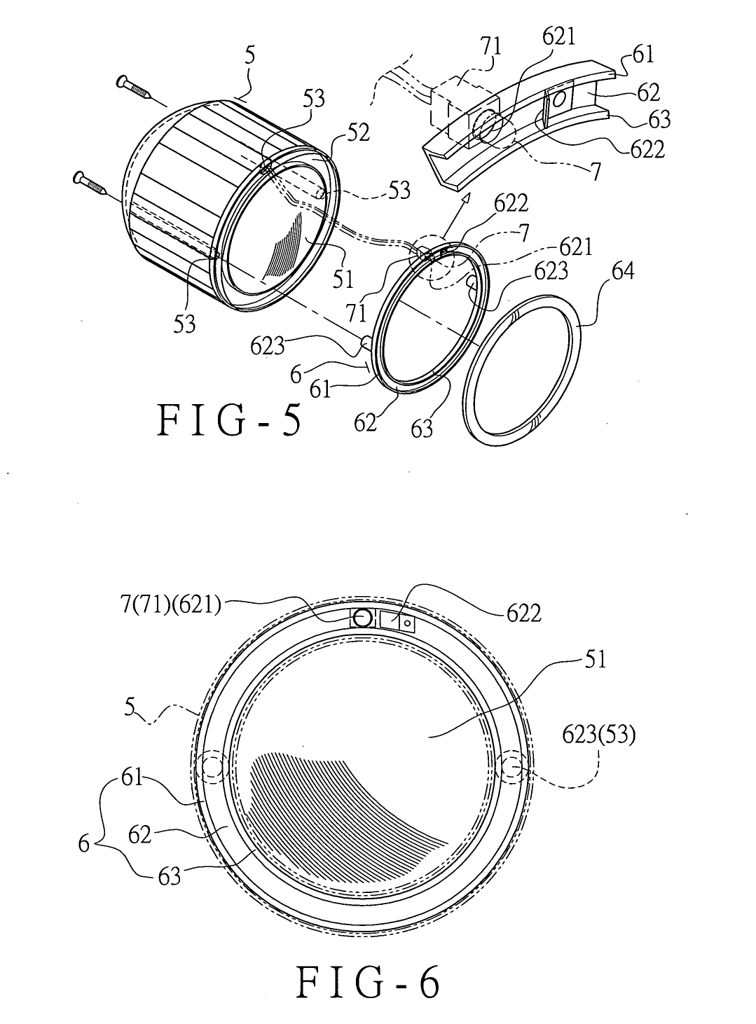

Referring to FIGS. 5 and 6, another preferred embodiment of an automobile light with an auxiliary spotlight diaphragm in the present invention includes a light base 5, a spotlight diaphragm 6 and a flickering diode 7.

The light base 5 is provided with a light source body 51 therein, the light source body 51 provides the main light source for illumination, an outer ring groove 52 is provided in the front end of the light source body 51 for receiving the spotlight diaphragm 6, and at least three holes 53 are provided in the predetermined positions of the outer ring groove 52.

The spotlight diaphragm 6 is designed to inlay in the outer ring groove 52 and pivotally provided around the outer circumference of the light source body 51. The spotlight diaphragm 6 is composed by a first light-reflection portion 61, a second light-reflection portion 62, and a third light-reflection portion 63. One hollow 621 is provided in a predetermined bottom position of the second light-reflection portion 62, so as for the flickering diode 7 to be inlaid therein, and a reflection piece 622 is provided adjacent to the flickering diode 7 in the second light-reflection portion 62. A pair of opposite connecting rods 623 are provided on the bottom of the second light-reflection portion 62 so as to respectively insert in two oposite holes 53 in the outer ring groove 52 for assembly. The flickering diode 7 may be provided with a base 71, and a transparent ring 64 may be provided at the front of the auxiliary spotlight diaphragm 6 to prevent from dust and to protect the flickering diode 7.

When being driven, the light source from the flickering diode 7 projects on the first light-reflection portion 61, the second light-reflection portion 62 and the third light-reflection portion 63, and because of the light-reflection function of the first light-reflection portion 61, the reflection piece 622 in the second light-reflection portion 62 and the third light-reflection portion 63, the automobile light can quickly provide the best illumination and be brilliant for warning.

While the preferred embodiments of the invention have been described above, it will be recognized and understood that various modifications may be made thereto and the appended claims are intended to cover all such modifications which may fall within the spirit and scope of the invention.

1. An auxiliary spotlight diaphragm being pivotally provided around the outer circumference of a light source body in a light base of an automobile light comprising:
a first light-reflection portion;
a second light-reflection portion, at least one hollow being provided in a predetermined position of said first light-reflection portion, so as for a flickering diode to be inserted therethrough and inlaid in said second light-reflection portion; and,
a third light-reflection portion.

2. An auxiliary spotlight diaphragm of an automobile light, as recited in claim 1, wherein a hollow may be provided in a bottom position of said second light-reflection portion for a reflection piece to be inlaid therein.

3. An auxiliary spotlight diaphragm of an automobile light, as recited in claim 1, wherein a transparent ring may be provided at the front of said auxiliary spotlight diaphragm.
